(19) United States
(12) Patent Application Publication
(10) Pub. No.: US 2005/0249928 A1
(43) Pub. Date: Nov. 10, 2005

(54) Ceramic element comprising a homogenous ceramic layer, and method for the production of said ceramic element

(75) Inventors: Karl Lubitz, Ottobrunn (DE); Carsten Schuh, Baldham (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHAFT, 80333 MUNCHEN (DE)

(21) Appl. No.: 10/527,158

(22) PCT Filed: Aug. 20, 2003
(86) PCT No.: PCT/DE03/02776

§ 371 Date: Mar. 9, 2005

(30) Foreign Application Priority Data
Sep. 11, 2002 (DE) 102 41 731.8

(51) Int. Cl. B32B 3/00

(52) U.S. Cl. 428/210

(57) ABSTRACT

A ceramic element includes at least one substantially homogeneous ceramic layer which is provided with a plurality of superimposed partial ceramic layers. The ceramic element can be produced by stacking partial homogeneous ceramic layers on top of each other in the form of ceramic green films, removing the binding agent, and sintering. The ceramic element can be compacted at a lower sintering temperature than conventional block sinters. Moreover, the ceramic layer of the ceramic element is provided with a low number of pores, enclosures, foreign phases, and other flaws and is highly homogeneous. The ceramic element particularly represents a piezoelectric bending transducer or a piezoelectric transformer. Advantageously, the bending transducer or transformer has electrodes so as to be electrically triggered, the electrodes being buried underneath another ceramic layer. The additional ceramic layer and/or the electrode layer are used as a diffusion barrier.

The invention relates to ceramic element with at least one substantially homogenous ceramic layer. A method for the production of said ceramic element is also specified.

A ceramic element of the type mentioned and a method for its production are known from U.S. Pat. No. 6,260,248 B1. The ceramic element is a piezo-actuator with a multi-layer structure. The piezo-actuator comprises a plurality of ceramic layers arranged one on top of the other with a ceramic material made of doped lead zirconate titanate Pb(Zr, Ti)O₃. An electrode layer made of a silver-palladium alloy and referred to as an internal electrode is arranged between two ceramic layers respectively.

To produce the piezo-actuator a plurality of-ceramic green films printed with the alloy are arranged one on top of the other to form a stack. The ceramic green films are made of a green ceramic. The green ceramic is an as yet uncompressed ceramic and comprises powdered lead zirconate titanate and an organic binder. The layer thickness of the green film is for example 100 μm.

The stack of printed green films is compacted. To this end the stack is laminated and then subjected to a heat treatment. The heat treatment includes removing the binding agent from the ceramic green films and then sintering. This produces a piezo-actuator with a multi-layer structure, the individual ceramic layers being substantially homogenous. The piezo-actuator as a whole is however not homogenous. The internal electrodes made of the silver-palladium alloy are arranged within the volume of the piezo-actuator. There is at least a first phase made of lead zirconate titanate and a further phase with the silver-palladium alloy. The individual phases respectively form a chemical and physical unit. Both phases are distributed in a non-homogenous manner over the entire piezo-actuator.

Generally the probability of the occurrence of mechanical stress in a non-homogenous ceramic element is relatively high. For example with the piezo-actuator described mechanical stresses occur at a phase boundary between the different phases in the event of polarization or during operation of the piezo-actuator, which can then result in a microcrack or the propagation of an already existing microcrack and therefore failure of the piezo-actuator. Different phases, which are distributed irregularly over the non-homogenous ceramic element, can be formed from a different ceramic material or inclusions. It is also possible for the phases to comprise a ceramic material of the same composition but different microstructure respectively.

The object of the present invention is to show how a substantially homogenous ceramic element can be produced.

To achieve this object a ceramic element with at least one substantially homogenous ceramic layer is specified. The ceramic element is characterized in that the ceramic layer has a plurality of homogenous partial ceramic layers arranged one on top of the other.

To achieve the object a method for producing said ceramic element is also specified. The method is characterized by the following method steps: a) arranging the homogenous partial ceramic layers one on top of the other to form a stack and b) compacting the stack, thereby forming the ceramic element with the ceramic layer.

The basic concept involves constructing the ceramic element or a ceramic layer of the ceramic element from a plurality of homogenous partial ceramic layers, thereby achieving a ceramic element with a homogenous ceramic layer. The partial ceramic layers can thereby have the same or different partial layer thicknesses. A homogenous partial ceramic layer for example comprises a single phase. The phase is for example formed from a single ceramic material, the composition of which is not a function of location. This means that there is no sudden change and almost no gradient in the composition of the ceramic material in the partial ceramic layer. It is however also possible for there to be more than one phase. For example the ceramic layer comprises different ceramic materials. The ceramic materials are distributed regularly over the entire partial ceramic layer. There is no concentration of one of the ceramic materials. Ceramic and non-ceramic phases can also be present. This non-ceramic phase is for example the organic binder of a green ceramic.

The homogenous partial ceramic layers are arranged one on top of the other such that the probability of the occurrence of a foreign phase between the partial ceramic layers is reduced. The ceramic layer, which comprises the homogenous partial ceramic layers, is therefore also homogenous. The partial ceramic layers can thereby have completely different compositions from each other. For example all the partial ceramic layers of the ceramic layer are made of lead zirconate titanate. The partial ceramic layers can however be distinguished from each other by the doping of the lead zirconate titanate (nature and proportion of doping). There can thus be a doping gradient in the ceramic layer for example. However the homogeneity of the ceramic layer remains unaffected by this. The ceramic layer as a whole comprises lead zirconate titanate. The crystal system of the lead zirconate titanate is virtually unaffected by the doping.

To produce the ceramic element with the homogenous ceramic layer, the homogenous partial ceramic layers are arranged directly one on top of the other. Essentially no permanent foreign phases occur between the partial ceramic layers. A permanent foreign phase would be formed for example by electrode material between the partial ceramic layers, which is not removed by subsequent compacting of the stack. A non-permanent phase is for example air, which is removed when the stack is compacted. The compacting of the stack produces the ceramic element with the substantially homogenous ceramic layer.

The homogenous ceramic layer is for example characterized by a regular microstructure. This results in an improvement in certain characteristics of the ceramic element compared with a non-homogenous ceramic layer. The ceramic element is a piezo-electric transformer for example. A small number of pores, inclusions, foreign phases or other defects in the ceramic layer result for example in a relatively high level of piezo-activity in the transformer. A homogenous polarization state is also achieved, which results in regular mechanical loading during operation of the transformer. This results in a long service life and high level of reliability of the transformer.

In a specific embodiment the partial ceramic layer has a ceramic material selected from the group of green ceramics and/or sintered ceramics.

Sintered ceramics are at least partially compressed ceramics. Green ceramics are as yet uncompressed ceramics. The ceramic element can be present as a sintered ceramic element or a green component (unsintered ceramic element). A sintered ceramic element is produced from the ceramic element in the form of a green component. Ceramic green films with a green ceramic are used for example as homogenous partial ceramic layers to produce the ceramic element in the form of a green component. These ceramic green films for example comprise a powdered ceramic material and an organic binder. The green films comprise homogenously distributed ceramic and non-ceramic material. Standard methods such as slip casting or film casting are used to produce the ceramic green films. The powdered ceramic material for example comprises calcined ceramic.

Subsequent laminating and sintering of the stack of green films produce the ceramic element with the homogenous ceramic layer comprising sintered homogenous partial ceramic layers. The partial ceramic layers comprise the sintered ceramic.

In a specific embodiment at least one of the partial ceramic layers has a partial layer thickness selected from the range 5 μm to 250 μm inclusive. At the specified partial layer thicknesses, the partial ceramic layers in the form of ceramic green films have very fine powdered ceramic materials. These very fine powdered ceramic materials result in improved chemical homogeneity of the green film, a higher level of sinter activity and therefore compression of the ceramic materials at lower temperatures. The sinter temperature is relatively low. With the method for producing ceramic green films with fine initial powders it is therefore possible to achieve good gas removal and filterability of the slip required for production of the ceramic green films. This means there is less probability of defects in the ceramic element to be produced. The particle size distribution (microstructure) within a partial ceramic layer produced from a ceramic green film is regular. The ceramic layer comprising partial ceramic layers is also characterized by this regular particle size distribution.

The stack of green films is for example compacted by laminating. Laminating includes for example uniaxial or isostatic compression of the ceramic green films in the stack.

Stack compacting in particular includes heat treatment of the stack. The heat treatment is for example removal of the binding agents of the green ceramic. The heat treatment in particular includes the sintering of the stack.

In a specific embodiment so many ceramic green films are stacked one on top of the other that a ceramic element results with a ceramic layer with an overall layer thickness selected from the range 10 μm to 5 mm inclusive. A ceramic element with a very thin homogenous ceramic layer can be realized as a function of the number of partial ceramic layers used and their partial layer thicknesses. In particular the ceramic element can also have a very thick, homogenous ceramic layer. This results in a solid ceramic element with a relatively thick homogenous ceramic layer. This thick homogenous ceramic layer in particular has an overall layer thickness of more than 400 μm. Compared with the ceramic layer of a solid ceramic element produced using a conventional method (compression method, block sintering) however the ceramic layer comprising partial ceramic layers is characterized by a significantly greater homogeneity.

In a further embodiment at least one electrode layer is arranged on at least one surface section of the ceramic layer. Preferably at least one further electrode layer is arranged on at least one further surface section of the ceramic layer such that the electrode layers are opposite each other and the ceramic layer is arranged between the electrode layers. Such a ceramic element is for example a capacitor.

In a further embodiment at least one of the electrode layers is arranged between the ceramic layer and at least one further ceramic layer. The ceramic layer is substantially covered by the further ceramic layer. The electrode layer is buried by the further ceramic layer. In the case of a piezo-electric component, the further ceramic layer is for example configured such that electrical and/or mechanical characteristics of the components are not or are scarcely influenced. Performance data of the component is maintained. The further ceramic layer is for example very thin. The further ceramic layer can thereby also function as a so-called buffer layer. This is for example advantageous, when the ceramic element is used in an atmosphere that is reactive to the electrode material of the electrode layer. For example the ceramic layer is used in an environment with a high level of air humidity. This could cause migration effects to occur in the electrode material, for example silver migration, and electrochemical diffusion processes. Increased electrical conductivity of the ceramic element could result. This would cause flashovers and short circuits. It is particularly advantageous, if the further ceramic layer has low reactivity to the ceramic material of the ceramic layer and partial ceramic layers and to a sinter environment during sintering.

There are various variants in respect of electrical contact with the electrode layer and the further electrode layer. For example the electrode layers are applied to separate, lateral surface sections of the ceramic element. An external metal coating is applied to the surface sections in each instance for electrical contact with the electrode layers. The external metal coating is for example applied using thick film technology or sputtering. Alternatively an electrical through contact can be provided in the further ceramic layer covering the electrode layer for the purposes of electrical contact. The electrical through contact is a through hole filled with electrically conductive material in the further ceramic layer. It is also possible for the further ceramic layer not to cover the electrode layer below it completely but to cover it only partially. This leaves a freely accessible contact area on the electrode layer.

The ceramic material is for example a perovskite. The ceramic material is in particular a piezo-ceramic. The piezo-ceramic is preferably a lead zirconate titanate. In the combination of the ceramic element with the ceramic material comprising lead zirconate titanate the invention is characterized by the following particular advantages: the use of thin ceramic green films with the powdered ceramic material means that the sintering temperature can be reduced to below 1,300° C. This has the advantage that certain components of the lead zirconate titanate, which are volatile during sintering, such as lead oxide (PbO) or manganese oxide (MnO) do not evaporate significantly, as they would during comparable block sintering at higher sintering temperatures. Also detrimental reactions to sintering aids (e.g. a support plate or capsule) only occur to a minor degree at lower sintering temperatures. A surface layer of the ceramic element or the ceramic layer, which is in contact with the sintering agent during sintering remains largely homogenous. The surface layer is not destroyed to a depth of 1 mm to 3 mm, as is the case with block sintering at higher temperatures. After production of the ceramic element the surface layer does not have to be removed by grinding, sawing, etc.

The electrode layer and the further ceramic layer are particularly advantageous in relation to lead zirconate titanate. Each of these layers can act as a diffusion barrier for the said volatile components of the lead zirconate titanate. Conversely these layers can also prevent the diffusion of unwanted foreign atoms from the environment. The composition of the lead zirconate titanate with a specific proportion of oxygen or a specific proportion of a doping substance does not change. The ceramic element is advantageously in contact with the sintering aids via a low-reactivity further ceramic layer during sintering.

The ceramic element is in particular selected from the group of piezo-electric transformers or piezo-electric bending transducers. Any other ceramic component, in which a ceramic layer of corresponding thickness is to be produced, is also possible. The use of multi-layer technology allows the ceramic element to be produced with a homogenous ceramic layer.

To summarize, the following advantages result with the invention:
A ceramic element can be realized with a substantially homogenous ceramic layer with a small number of pores, inclusions, foreign phases and other defects. The ceramic layer has a high level of homogeneity and a regular microstructure.
The high level of homogeneity and regular microstructure result in a reduced probability of the occurrence of microcracks and macrocracks during mechanical or thermal loading of the ceramic element. The growth of existing cracks is suppressed. This results in a long service life and high level of reliability of the ceramic element.
During production of the ceramic layer comprising ceramic green films compression takes place at a relatively low sintering temperature. A low sintering temperature results in a regular microstructure. The regular microstructure also occurs in particular in a marginal area (surface layer) of the ceramic layers.

The invention is described in more detail below with reference to a plurality of exemplary embodiments and the associated figures. The figures are schematic and do not represent scale images.

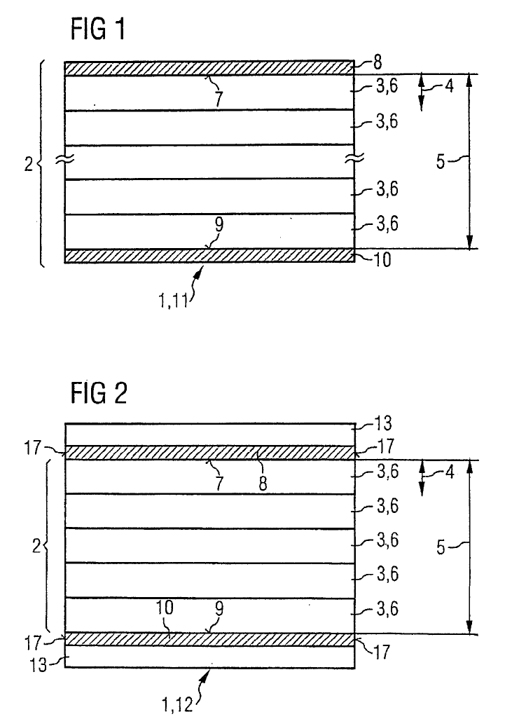

FIG. 1 shows a section of an exemplary embodiment of the ceramic element in the form of a transformer.

FIG. 2 shows a section of an exemplary embodiment of the ceramic element in the form of a bending transducer.

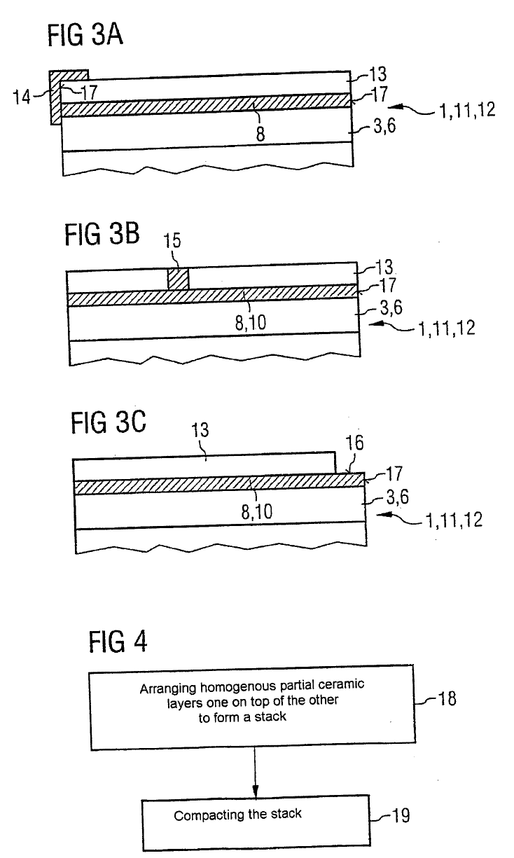

FIGS. 3A to 3C show different options for electrical contact with a buried electrode layer of the ceramic element.

FIG. 4 shows a method for producing the ceramic element.

### Exemplary Embodiment 1

The ceramic element 1 is a piezo-electric transformer 11 (FIG. 1). The piezo-electric transformer 11 comprises a substantially homogenous ceramic layer 2, which has an electrode layer 8 and 10 on two opposing surface sections 7 and 9 respectively. The homogenous ceramic layer 2 comprises a plurality of homogenous partial ceramic layers 3 arranged one on top of the other. The partial ceramic layers 3 and therefore the ceramic layer as a whole 2 comprise ceramic material 6 in the form of sintered ceramic. The piezo-electric transformer 11 is a sintered ceramic element 1. The ceramic material 6 is lead zirconate titanate.

Each of the partial ceramic layers 3 has a partial layer thickness 4 of around 20 μm. 20 such partial ceramic layers are arranged one on top of the other. The piezo-electric transformer 11 has a homogenous ceramic layer 2 with an overall thickness 5 of around 500 μm.

### Exemplary Embodiment 2

According to a further exemplary embodiment (not shown) of the transformer 11, the electrode layers 8 and 10 corresponding to the electrode layers 8 and 10 of the bending transducer 12 of the second exemplary embodiment (see FIG. 2) are buried under further ceramic layers 13.

### Exemplary Embodiment 3

The ceramic element 1 is a piezo-electric bending transducer 12 (FIG. 2). Compared with the transformer described above, the homogenous ceramic layer of the bending transducer comprises five homogenous partial ceramic layers with partial layer thicknesses of around 20 μm. To maximize deflection the electrode layers 8 and 10 are applied up to an edge of the homogenous ceramic layer 2 and therefore to a lateral surface section 17 of the piezo-ceramic bending transducer 12.

The electrode layers 8 and 10 are largely covered by a further ceramic layer 13 each. The layer thickness of the further ceramic layers 13 is around 10 μm. The electrode layers 8 and 10 are buried under the further ceramic layers 13. The piezo-electric bending transducer 12 can therefore also be used in a damp environment that is reactive to the electrode material of the electrode layers 8 and 10 with a high level of long-term stability.

### Exemplary Embodiment 4

According to a further exemplary embodiment (not shown) of the bending transducer 12, the electrode layers 8 and 10 corresponding to the electrode layers 8 and 10 of the transformer 11 of the first exemplary embodiment are not covered by further electrode layers and are freely accessible (see FIG. 1).

For electrical contact with the electrode layer 8 or 10 concealed beneath the further ceramic layer 13, according to a first embodiment an external metal coating 14 is applied by sputtering to the lateral surface section 17 of the transformer 11 or bending transducer 12 (FIG. 3A). In a second embodiment electrical contact is achieved by means of an electrical through contact 15 (FIG. 3B). According to a third embodiment electrical contact is achieved via a freely accessible free contact area 16 of the respective electrode layer 8 and 10 not covered by the further ceramic layer 13 (FIG. 3C).

Homogenous partial ceramic layers in the form of ceramic green films with a green ceramic are used as the basis for producing the piezo-electric transformer or piezo-electric bending transducer. The ceramic green films are arranged one on top of the other to form a stack (18, FIG. 4). A matrix is used for this, to allow precise stacking of the ceramic green films. The stack is then compacted (19, FIG. 4). This is done by compressing the stack uniaxially (laminating). In an alternative embodiment compacting takes place by means of isostatic pressure. After laminating the stack is subjected to a heat treatment. The heat treatment thereby includes removal of the binding agents and then sintering.

1-14. (canceled)

15. Ceramic element (1) with at least one substantially homogenous ceramic layer (2),
the ceramic layer (2) having a plurality of partial ceramic layers (3) arranged one on top of the other,
at least one electrode layer (8) being arranged on at least one surface section (7) of the ceramic layer (2),
at least one further electrode layer (10) being arranged on a further surface section (9) of the ceramic layer (2) such that the electrode layers (8, 10) are arranged opposite each other and the ceramic layer (2) is arranged between the electrode layers (8, 10), characterized in that
at least one of the electrode layers (8, 10) is arranged between the ceramic layer (2) and at least one further ceramic layer (13).

16. Ceramic element according to claim 15, wherein the partial ceramic layers (3) have a ceramic material (6) selected from the group of green ceramics and/or sintered ceramics.

17. Ceramic element according to claim 15, wherein at least one of the partial ceramic layers (3) has a partial layer thickness (4) selected from the range 5 μm to 250 μm inclusive.

18. Ceramic element according to claim 15, wherein the ceramic layer (2) has an overall layer thickness (5) selected from the range 10 μm to 5 mm inclusive.

19. Ceramic element according to claim 16, wherein the ceramic material (6) comprises a piezo-ceramic.

20. Ceramic element according to claim 19, wherein the piezo-ceramic (6) is a lead zirconate titanate.

21. Ceramic element according to claim 15, wherein the element (1) is selected from the group of piezo-electric transformers (11) or piezo-electric bending transducers (12).

22. Method for producing a ceramic element according to claim 15, which comprises the following method steps:
a) arranging the homogenous partial ceramic layers one on top of the other to form a stack; and
b) compacting the stack, the ceramic element being formed with the ceramic layer.

23. Method according to claim 22, wherein ceramic green films with a green ceramic are used as the homogenous partial ceramic layers.

24. Method according to claim 22, wherein the step of compacting the stack includes laminating.

25. Method according to claim 22, wherein the step of compacting the stack includes heat treatment of the stack.
